(19) United States
(12) Patent Application Publication
(10) Pub. No.: US 2020/0193513 A1
(43) Pub. Date: Jun. 18, 2020

(54) ONLINE LENDING PLATFORM PROVIDING FIRM OFFERS OF CREDIT

(71) Applicant: Fintech Credit Innovations Inc., St. Petersburg, FL (US)

(72) Inventors: Timothy RANNEY, St. Petersburg, FL (US); Matthew GHOURDJIAN, Crestone, CO (US)

(21) Appl. No.: 16/224,329

(22) Filed: Dec. 18, 2018

(51) Int. Cl. G06Q 40/02; G06Q 20/22; G06F 3/0482

(52) U.S. Cl. CPC G06Q 40/025; G06F 3/0482; G06Q 20/227

(57) ABSTRACT

A consumer driven online lending platform obtains information regarding a loan candidate sufficient for a lender to obtain requisite qualifying information for a loan product. The lending platform may result in firm offers of credit to a loan candidate from a lender. A loan candidate may select among multiple firm offers of credit to select the best loan product for the loan candidate. The online lending platform is configured such that only a single instance of a credit report is pulled for a loan candidate so that multiple copies of the credit report are not pulled by different respective lenders. The personal information regarding the loan candidate, the credit and verification documentation are not passed to a lender until the loan candidate accepts an offer from the lender.

### BACKGROUND OF THE INVENTION

With a typical conventional online lending platform, a consumer accesses a website and is prompted to provide personal information and to identify a type of loan product that is of interest. After the consumer provides personal information to the platform and identifies the type of loan product the consumer is interested in, the information gathered from the consumer is forwarded to a number of potential lenders. These potential lenders may each pull a credit report for the consumer and then decide whether to contact the consumer or not. In many instances, a consumer may receive solicitations from a large number of lenders. These solicitations take the form of invitations to apply for particular loan products by the lender.

Thus, the consumer must go through the process of applying for a loan product separately for each of the potential lenders. This may prove to be an onerous process. Moreover, the consumer has no guarantee that he/she will qualify for the loan product. An additional drawback of conventional online lending platforms is that the consumer's credit report may be pulled a large number times in response to a single instance of visiting the online lending platform. This may affect the consumer's credit rating in a negative fashion.

Another drawback for the consumer is that the consumer may receive a very large number of solicitations over an extended period from potential lenders. These solicitations may be received even after the consumer has already obtained a loan or is no longer interested in obtaining a loan. In addition, each lender is in possession of all of the information provided by the consumer in completing the loan application. This information may be used to send the consumer unwanted spam. A further drawback for the consumer is the sheer time and effort required to complete separate applications for each loan product. This time and effort may, in many instances, not even result in qualifying and getting a loan.

The conventional online lending platforms may also be challenging for lenders because, for each consumer, the lender must pay a fee for obtaining a credit report. Cumulatively, these fees are substantial in order to find a single qualified applicant. Moreover, the lender has no assurance that the consumer will choose to apply for a loan product from that lender as the consumer may be looking at a large number of different potential lenders. As a result, the rate of obtaining a loan based upon a solicitation by a consumer via the online lending platform is often quite low.

### SUMMARY

In accordance with one aspect of exemplary embodiments, a method is performed by a processor of a computing device. In this method, a user interface is transmitted to obtain personal information for a loan candidate. The personal information is received via the user interface. A user interface to obtain a credit report from the loan candidate is transmitted, and the credit report is received for the loan candidate. A user interface is transmitted for the loan candidate to upload a document verifying income for the loan candidate. The document verifying income for the loan candidate is uploaded and received. The document(s) may be analyzed by machine logic to ensure that it verifies income information and other information provided by the loan candidate. The analyzing may be manually and/or by machine logic. The personal information, the credit report and the document verifying income for the loan candidate are processed to obtain a set of qualifying information for the loan candidate. Loan products offered by at least three lenders are filtered using the set of qualifying information to identify at least one of the loan products for which the loan candidate qualifies. A user interface is transmitted that indicates that the loan candidate qualifies for one or more of the at least one loan products and provides an “apply” element that enables the loan candidate to apply for one of the one or more loan products. Based on the loan candidate applying for a given one of the loan products for which the loan candidate qualifies via the apply element, information is forwarded to participating lenders to approve or deny, with approvals taking the form of a fully defined, “firm” offer of credit, subject only to a restricted set of fully disclosed conditions (such as verification of specified application information). In some instances, up to four firm offers are then displayed in fully comparable form, including all legally required characteristics, such as APR, providing a competitive market of comparable firm offers of credit for the loan candidate to select from. If the consumer accepts an offer, a full application file is forwarded to the lender for final processing and funding.

The method may further include providing an element that identifies loan products for which the loan candidate qualifies based on information regarding the loan candidate that is received and updating the element when additional information regarding the loan candidate is received. This element may be updated in real time or near real time as the filtering is performed. The method may also include gathering verifying information from the loan candidate to help in obtaining the credit report for the loan candidate.

The method may further include receiving qualifying rules that identify what are qualifying characteristics that need to be satisfied to qualify for at least one loan product. The filtering may comprise applying such qualifying rules to the set of qualifying information. The user interfaces may be for a smart phone or for other types of computing devices.

Instructions for performing this method by a processor or computing device may be stored on a non-transitory computer readable storage medium.

In accordance with another aspect of exemplary embodiments, a method may be performed by a processor of a computing device such that a list of loan products available to a loan candidate are output. A user interface is provided for the loan candidate to enter personal information that may affect what loan products are available to the loan candidate. A first piece of personal information is received via the user interface regarding the loan candidate. The list of loan products output is updated based on the first piece of personal information. A second piece of personal information is received via the user interface regarding the loan candidate. The list of loan products output is updated based on the second piece of personal information.

The first piece of personal information may be from a credit report, for instance. The first piece of personal information, for example, may instead be input to the computing device via a user interface.

Instructions for performing this method by a processor of a computing device may be stored on the non-transitory computer readable storage medium.

### BRIEF DESCRIPTION OF THE DRAWINGS

FIG. 1 is a flowchart that provides an overview of the steps that may be performed in exemplary embodiments via the online lending platform.

FIG. 2A shows an exemplary user interface for a lender to specify mandatory fields that are required from a loan candidate in an exemplary embodiment.

FIG. 2B shows an illustrative user interface for a lender to enter qualifying rules for a loan product in an exemplary embodiment.

FIG. 3 is a flowchart illustrating steps that may be performed to provide personal data in exemplary embodiments.

FIG. 4A shows an illustrative user interface for a loan candidate to begin providing personal data via an exemplary online lending platform.

FIG. 4B shows an illustrative user interface in which a loan candidate is prompted to enter current loan information.

FIG. 4C shows an illustrative user interface in which a loan candidate is prompted to specify parameters regarding a new loan request.

FIG. 5A shows an illustrative user interface in which a loan candidate is prompted to provide personal and contact information.

FIG. 5B shows an illustrative user interface in which a loan candidate is prompted to provide identification information.

FIG. 6A shows an illustrative user interface in which a loan candidate is prompted to obtain a copy of a credit report.

FIG. 6B shows an illustrative user interface in which a loan candidate is prompted to provide verifying information to obtain a credit report.

FIG. 6C shows an illustrative user interface in which a credit report for a loan candidate is displayed.

FIG. 6D shows an illustrative user interface in which a loan candidate has declined to obtain a credit report.

FIG. 7 shows an illustrative interface in which the system attempts to reconcile information obtained with the credit report versus information entered by a user.

FIG. 8A shows an illustrative user interface in which a loan candidate is prompted to provide employment and income information.

FIG. 8B shows an exemplary user interface for uploading income verifying documents.

FIG. 8C shows a flowchart depicting steps that may be performed to verify income information.

FIG. 9 shows an illustrative user interface in which banking information and debit card information is solicited from a loan candidate.

FIG. 10 depicts an illustrative distributed environment for practicing exemplary embodiments.

FIG. 11 is a block diagram depicting major modules of the lending platform in exemplary embodiments.

FIG. 12 is a diagram illustrating data flow of information that is gathered from a loan candidate in exemplary embodiments.

FIG. 13A is a diagram illustrating the filtering of loan products by lenders via information obtained via personal qualifying information obtained from a loan candidate.

FIG. 13B illustrates an example of some of the filtering performed in exemplary embodiments.

FIG. 14 shows an illustrative user interface in which loan offers are displayed to a loan candidate.

FIG. 15 depicts an illustrative user interface in which firm offers of credit are displayed to a loan candidate.

FIG. 16 depicts interactions between the online lending platform and a lender via API's in exemplary embodiments.

### DETAILED DESCRIPTION

The exemplary embodiments described herein overcome a number of the limitations discussed above regarding conventional online lending platforms. The exemplary embodiments provide a consumer driven online lending platform that results in firm offers of credit to a loan candidate, such as a consumer. These are binding offers of credit that a loan candidate may accept and not mere invitations to apply for a loan. A firm offer of credit is a term of art and refers to an offer of credit to a consumer that will be honored if the consumer meets the specific criteria specified for the offer, which conditions may be limited (e.g., revised credit underwriting based on previously received credit reports is not permitted). Thus, the loan candidate does not run the risk of wasting time by applying for a number of different potential loan products, having the applications rejected or the terms modified relative to what was initially presented. Moreover, the loan candidate is provided with the terms of offers and may compare offers to select the most suitable offer.

Another benefit of the online lending platform of the exemplary embodiments is that a loan candidate's credit report will be pulled only a single time in order to match the loan candidate to potential loan products. This benefits the loan candidate in that there is not a deleterious effect on the credit rating of the loan candidate due to multiple entities pulling a credit report prior to narrowing the range of lender matches and being subject to final underwriting. Final underwriting to produce a firm offer from multiple lenders may entail a hard pull be each per-qualified lender. This reduction in the number of credit pulls is also beneficial to the lenders in that the lenders do not have to pay for the credit report to be pulled until a loan candidate is pre-qualified and thus reduces the cost of considering the loan candidate for a loan product.

An additional benefit of the online lending platform of the exemplary embodiments is that the loan candidate is in charge of distribution of personal information. The personal information, the credit report and the verification documentation are not passed to a lender until the load candidate dictates that this information shall be passed to the lender by choosing to apply for a pre-qualified loan product. The information remains confidential to the online lending platform until an offer is requested. In some instances, by contractual agreement, participating lenders who receive requests for offers may not use the information to contact the candidate unless the consumer accepts that particular lender's offer. The loan candidate is not harangued with a large number of solicitations and is not bothered on an ongoing basis as each lender that has an appropriate loan product offers a firm offer of credit that is either accepted or rejected by the loan candidate. Further, the loan candidate only needs to provide the requested information once instead of multiple time for multiple lenders. Still further, the loan products that the loan candidate is invited to apply for are those which the loan candidate is likely to qualify for and thus, the online lending platform does not waste the time of the loan candidate.

Exemplary embodiments are able to provide firm offers of credit because the online lending platform facilitates the gathering of the requisite information from the loan candidate to satisfy the lenders that the loan candidate qualifies for the loan. Lenders specify through a lender interface the information necessary to provide a firm offer of credit. Thus, the lender knows that the loan candidate possesses the requisite qualifying characteristics before the firm offer of credit is offered to the loan candidate. The exemplary embodiments may provide user interfaces for gathering personal qualifying related information from the loan candidate. These user interface may be transmitted from a server to a client for display at the client or may be transmitted by an app running on the client to a client display device. The exemplary embodiments also may provide a mechanism for assisting the loan candidate in pulling a credit report and providing the credit report to the online lending platform. Still further, the online lending platform may provide a mechanism for a loan candidate to upload documents or images of documents that contain income validating information that may be processed by either logic accessible by the online lending platform or manually by designated parties.

The description below will focus on the loan candidate being a consumer seeking an unsecured personal loan to replace an existing loan. It should be appreciated, however, that the online lending platform may offer other types of loan products included secured loans, such as mortgages and car loans. In addition, the loan candidate need not be a consumer but can be an agent or representative of an organization, such as a corporation, partnership or sole proprietorship. Still further, the loan products need not be for paying off an existing loan but rather may be an original loan or a refinancing of an existing loan.

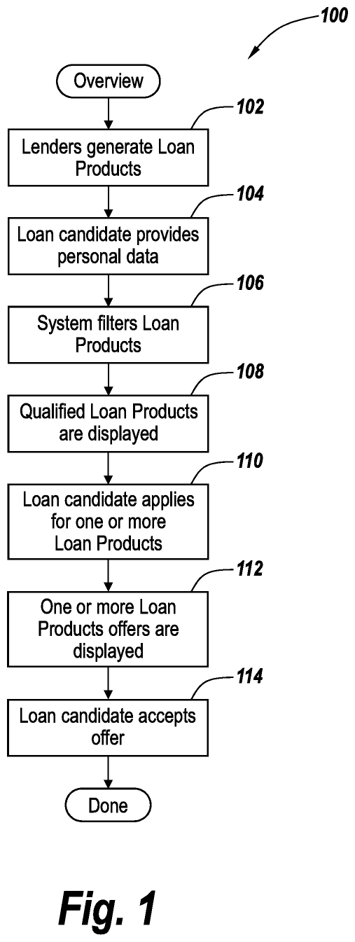

FIG. 1 shows a flowchart 100 of the steps that may be performed in exemplary embodiments for a loan candidate to obtain a firm offer of credit from a lender for a given lending product. Initially, in step 102 the lenders generate loan products that are stored for the online lending platform. As will described in more detail below, the online lending platform allows lenders to be on-boarded and to generate various tailored lending products. The lenders specify the characteristics of the lending products, such as annual percentage rate (APR), duration, and amount limits. The online lending platform also enables the lender to specify qualifying rules that are applied for each loan product. These qualifying rules may specify the criteria that must be satisfied for a loan candidate to qualify for the product.

Next, a loan candidate provides personal data to the online lending platform in step 104. The online lending platform may take the form of a website that may be accessible by a number of different types of client devices, including but not limited to computing devices, such as laptop computers, tablet computers, desktop computers or other types of devices, such as smart phones, gaming platforms and the like that provide internet access. Through the website, a loan candidate may provide personal information via user interfaces as will be described in more detail below.

The online lending platform contains filtering logic for filtering what loan products by which lenders are available to the loan candidate based on the information gathered from the loan candidate. The available loan products are those for which the loan candidate qualifies based on the qualifying characteristics specified for the loan products. In exemplary embodiments, the filtering may be iterative and may be performed in real time or close to real time as personal information is obtained as will be described in more detail below.

Once the personal information has been obtained, including credit report information and income validating documentation, qualified loan products are displayed in step 108. In other words, the loan products for which the loan candidate qualifies are displayed for selection by the loan candidate. The online lending platform has filtered the loan products based upon the information and loan parameters provided by the loan candidate. Once the consumer credit report is received by the system and is parsed, a large number of credit attributes may be derived and made available to the lenders in the form of qualification statements. The lender then uses the qualification statements to build product underwriting logic

The lenders have described their specific loan product offerings in the “system” using qualification statements which describe in detail their product underwriting guidelines (e.g. FICO score between 610 and 680 or debt to income ratio). The system does not share any information with the lenders at any time during the application process, but as each field in the application is completed, every qualification statement, for every loan product in the system, is used to refine and filter so that loan candidates have a real time view of the loan products they are qualified to receive. At the end of the application process the results are then displayed in detail in a price comparison view so that the consumer can select which products they wish to receive firm offers of credit. The result is that the products that are shown to the loan candidate in the price comparison view are only products (using deduction) that are prequalified to receive and offer.

The loan candidate then may apply to receive an offer for one or more loan products by selecting the one or more displayed loan products (step 110). The collected data is pushed to the selected lenders (step 112). The loans may craft firm offers of credit or a denial. The lenders may also choose to not respond (step 114). In response, one or more loan product offers are displayed to the loan candidate (step 116). These offers contain the particulars of the major terms of the loan product and invite the loan candidate to accept an offer. As was mentioned above, these offers are firm offers of credit. As such, the loan candidate is fairly certain that the loan will be realized provided that the information that has been furnished is legitimate and accurate. The displayed information may include a button or other activatable user interface component that may enable the loan candidate to accept an offer (step 118). There is interaction between the online lending platform and lenders to facilitate the offer and acceptance as will be described below. The lender is informed if offer is accepted and provided documents that loan candidate uploaded (step 120). The lender then publishes to the system the details of the funded loan including things such as term, APR, interest rate and loan amount (step 122).

As was mentioned in step 102 of FIG. 1, the lenders generate loan products that are available through the online lending platform. For each loan product, the lender may design and implement consumer qualification statements. These consumer qualification statements specify what characteristics the loan candidate must have and what information loan candidate must provide in order to qualify for a particular loan product or set of loan products.

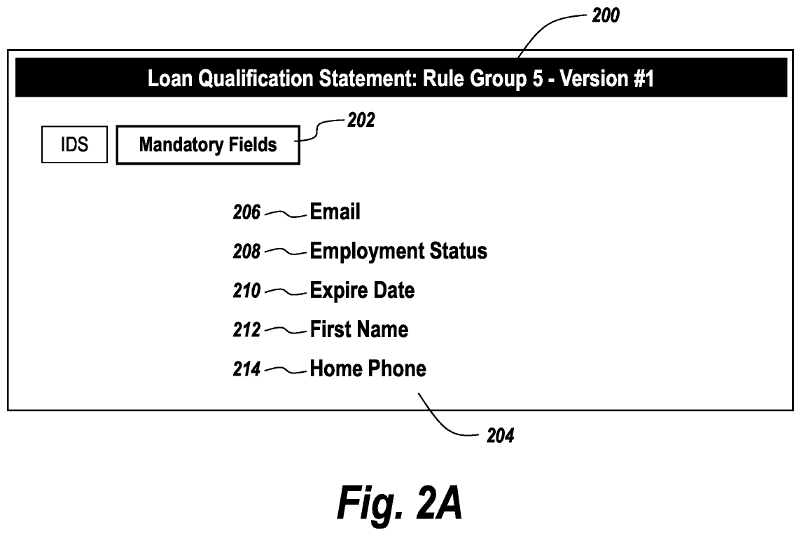

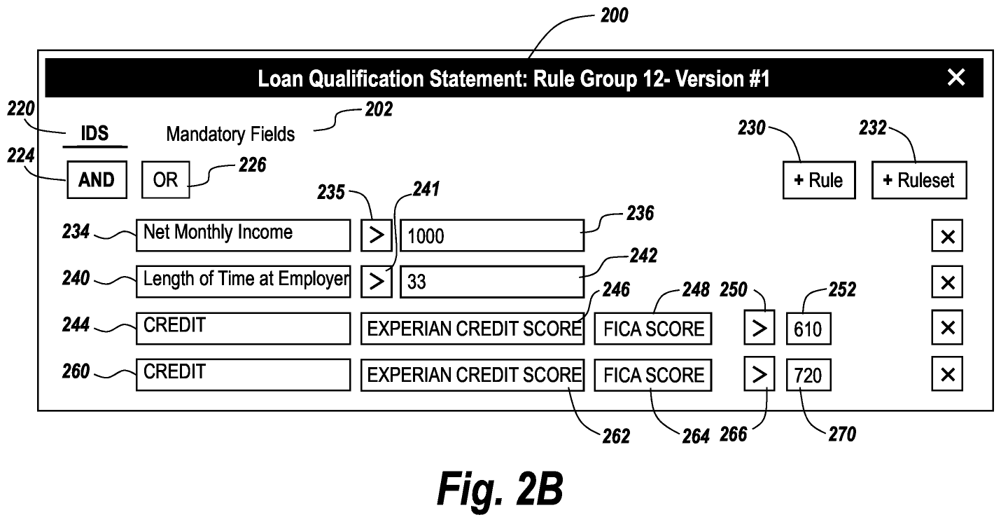

The online lending platform may provide a user interface such as that shown in FIG. 2A for creating a consumer qualification statement for a loan product or products. As shown in FIG. 2A, the user interface 200 includes a mandatory fields tab 202 that may be selected to indicate whether various fields are mandatory and must be present in order for a loan candidate to qualify. These fields will be provided via user interface in some exemplary embodiments to solicit the requisite information. The options shown in FIG. 2A in the menu 204 include email 206, employment status 208, expire date 210, first name 212 and home phone 214. If the loan candidate does not provide the mandatory fields information, the loan product or group of products may be removed from those that are considered qualified by the loan candidate.

FIG. 2B shows an example where tab 220 has been selected in the user interface 200 so that custom consumer qualification rules may be specified. The rule is constructed using the user interface 200. The rule may be constructed to have a logical AND relationship by selecting the AND element 224 or a logical OR relationship by selecting the OR element 226 and specifying the various fields that are depicted below these elements 224 and 226. In the example shown in FIG. 2B, field 234 is selected net monthly income and operator 235 indicates that the net monthly income must be greater than the value specified in field 236 in order to qualify. In addition, field 240 specifies a minimum time at a current employer and element 241 is selected to be greater than such that the value in field 242 is a minimum time at the current employer for the loan candidate. Thus, in order to qualify for this loan product or products, the loan candidate must have a length of time at the current employer that exceeds thirty weeks. Field 244 specifies that the credit as reflected in Experian credit score 244 must be greater than the value specified in field 252 in order to qualify for the loan product. Field 260, specifies that the FICO score must exceed the value specified in field 270.

The lender may create a number of these rules for a particular loan product or groups of loan products using such an interface.

It will be appreciated that an alternative embodiments, the lenders need not use the user interface to create the rules and specify the mandatory fields but instead may provide input in the form of files or in other forms that specify the necessary information. These qualification statements are used in the filtering of lenders and loan products that was discussed above relative to step 106 in FIG. 1.

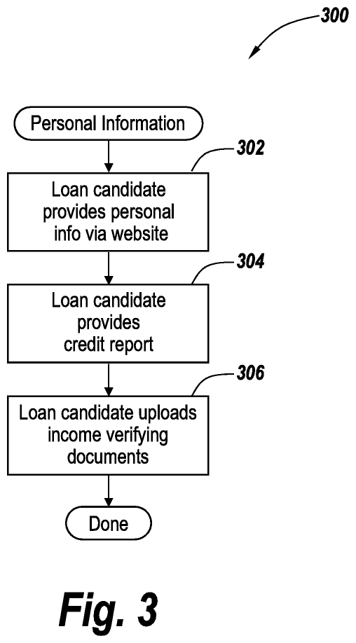

As mentioned above, in step 104, the loan candidate provides personal information. FIG. 3 depicts the steps that are performed to provide personal information in more detail. In particular, as shown in flowchart 300 in FIG. 3, the loan candidate provides personal information via a website by entering information on a web form or other web provided user interface (step 302). Examples of user interface elements for gathering such personal information will be described in more detail below. The personal information also includes data found on a credit report particular to the loan candidate. As was mentioned above, in the exemplary embodiments, the loan candidate provides a credit report to the online lending platform (step 304). The personal data also may include income verifying documents. As was mentioned above, the online lending platform in exemplary embodiments may provide an ability for the loan candidate to upload such documents or to upload an image of such documents (step 306). For example, a loan candidate may take a photo of the income verifying documents and send the image to the online lending platform via a user interface mechanism provided on the platform.

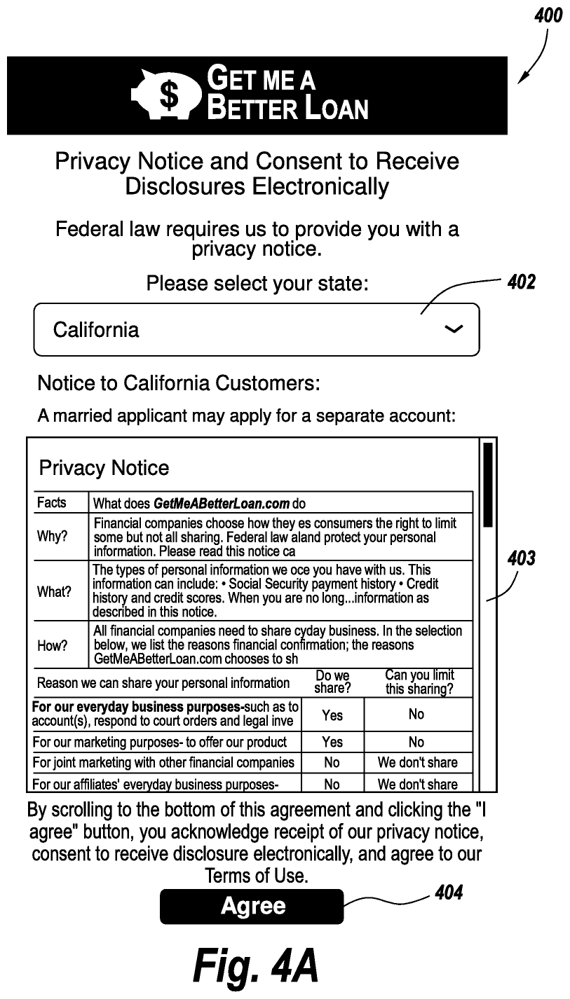

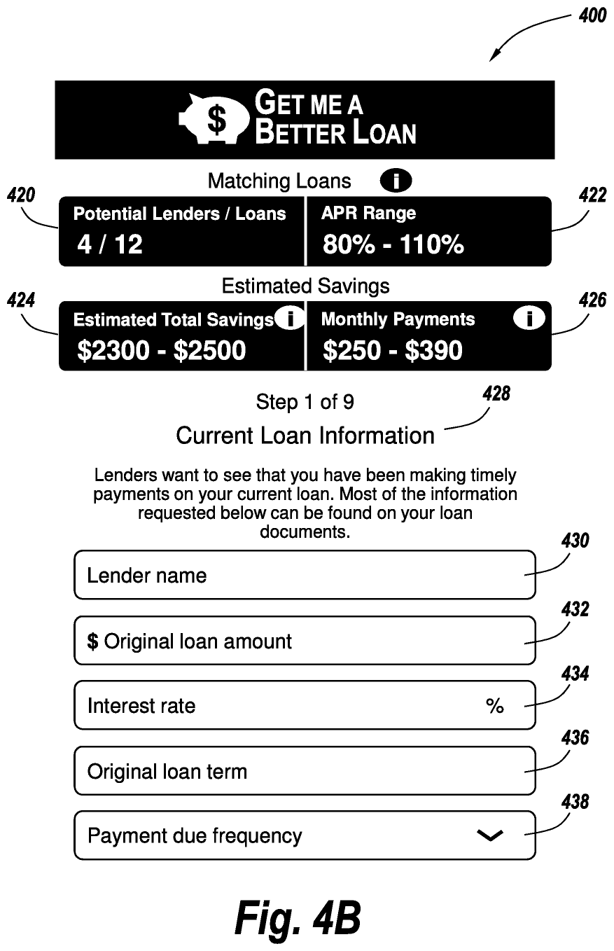

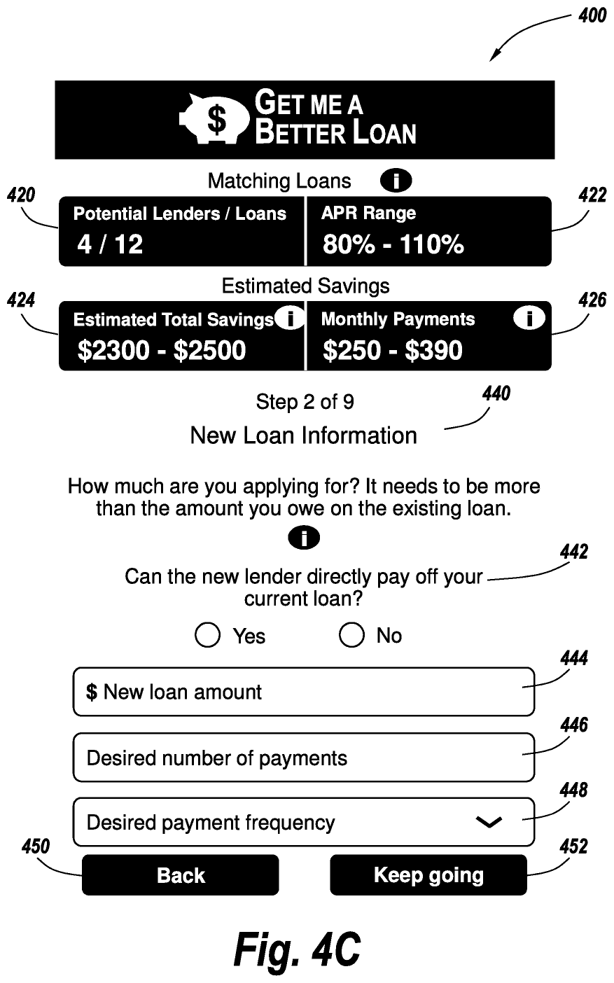

FIG. 4A shows an example of illustrative user interface 400 that may be used to gather personal data from a loan candidate via a website, such as performed in step 302 of FIG. 3. In the example shown in FIG. 4A, a dropdown list 402 enables a loan candidate to specify the state in which they are resident and for which they wish to obtain a loan product. In the example shown in FIG. 4A, the loan candidate has selected California as the state. In response to this selection, a privacy notice 403 is displayed that is particular for California consumers. A button 404 may be provided to acknowledge that the loan candidate has acknowledged receipt of the privacy notice and to agree to the terms of use for the website.

The loan candidate then goes through various steps to provide personal information, information regarding the desired loan and the current loan and to select qualified loan products. In FIG. 4B, the illustrative user interface 400 seeks to solicit current loan information 428. Thus, the loan candidate is prompted to provide the lender name 430, the original loan amount 432, the interest rate for the loan 434, the original loan term 436 and the frequency at which payments are due 438.

The user interface 400 may also have a scoreboard 420 that specifies the number of potential lenders and the number of potential loans. This scoreboard 420 is updated based upon the entered personal information and loan information. The loan candidate has provided information that he/she resides in California. The scoreboard 420 shows initially how many lenders and loan products are available in California. The range of APR for the loan products are shown in element 422. As the loan candidate enters the current loan information, field 424 shows an estimate the total savings of the products that may be realized over the duration of the loan as well as an estimate 426 of monthly payments for the range of qualifying loan products.

The loan candidate may then request to provide information regarding the new loan. FIG. 4C shows an example of a user interface 400 providing a user interface soliciting new loan requests information 440. In the illustrative user interface 400 shown in FIG. 4C, the loan candidate is requested to indicate whether the new lender can directly pay off the old loan (see 442). A field 444 is provided to enter the amount of the loan that the loan candidate is seeking. Field 446 is used to enter the desired number of payments for the new loan, and field 448 is used to specify the desired payment frequency for the new loan. A button 450 is provided to return to the previous screen. Button 452 is provided to continue with the process.

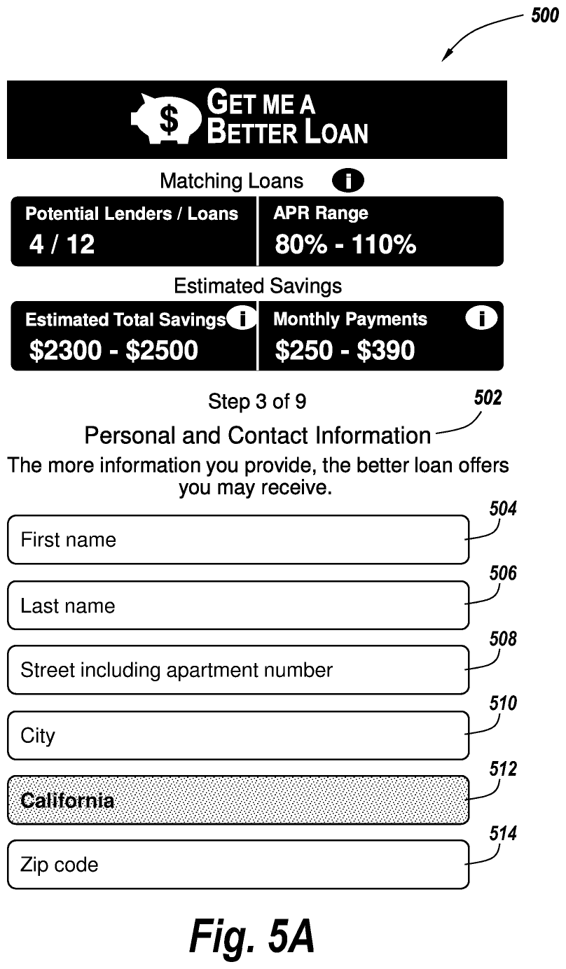

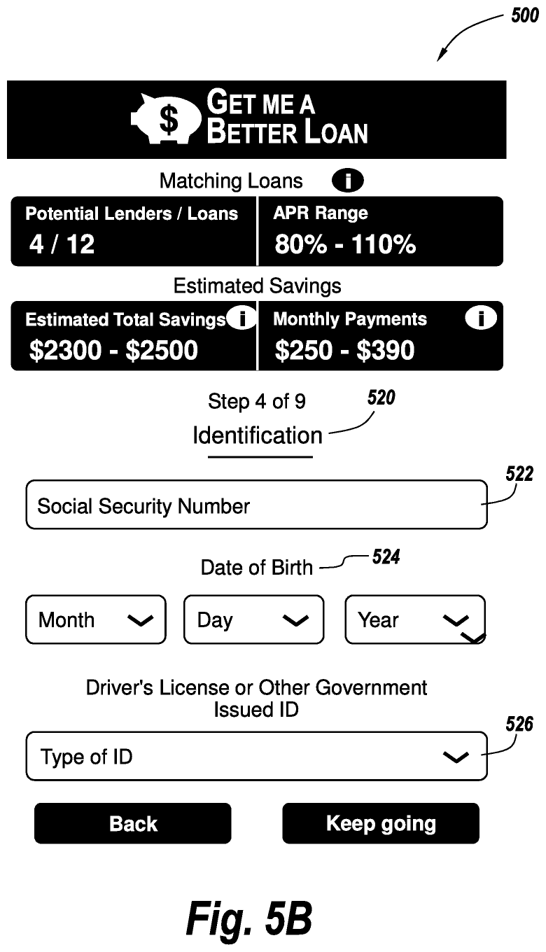

As was mentioned above, the information solicited from the loan candidate is not limited to information regarding the old loan and the new loan. Personal information is also solicited. FIG. 5A shows an example of an user interface 500 that is seeking to gather personal and contact information 502 from the loan candidate. Field 504 is provided for the loan candidate to enter their first name, and field 506 is provided for the loan candidate to enter their last name. The street address may be entered in field 508, and the city of residence may be specified in field 510. Field 512 is used to enter the state of residence and is already filled in as the loan candidate has previously specified the state of residence. In this example case, the loan candidate has already specified California as a state of residence. Field 514 is provided to enter zip code information for the loan candidate.

FIG. 5B shows an illustrative user interface 500 that may be provided to gather identification information 522 for the loan candidate. Field 522 is provided for the loan candidate to enter their social security number. Field 524 is provided for entering a date of birth, and field 526 is provided to specify a type of ID that the loan candidate wishes to submit for identification purposes.

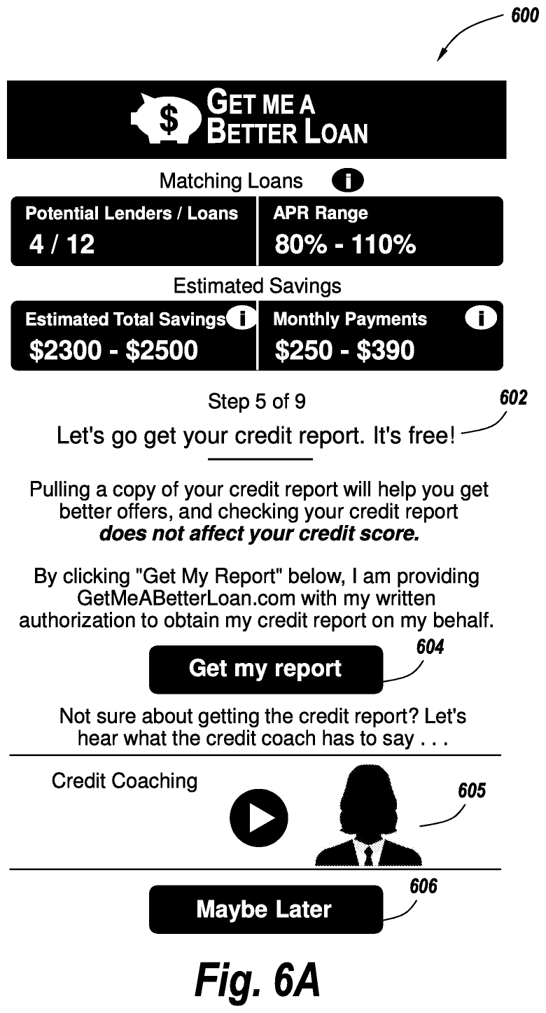

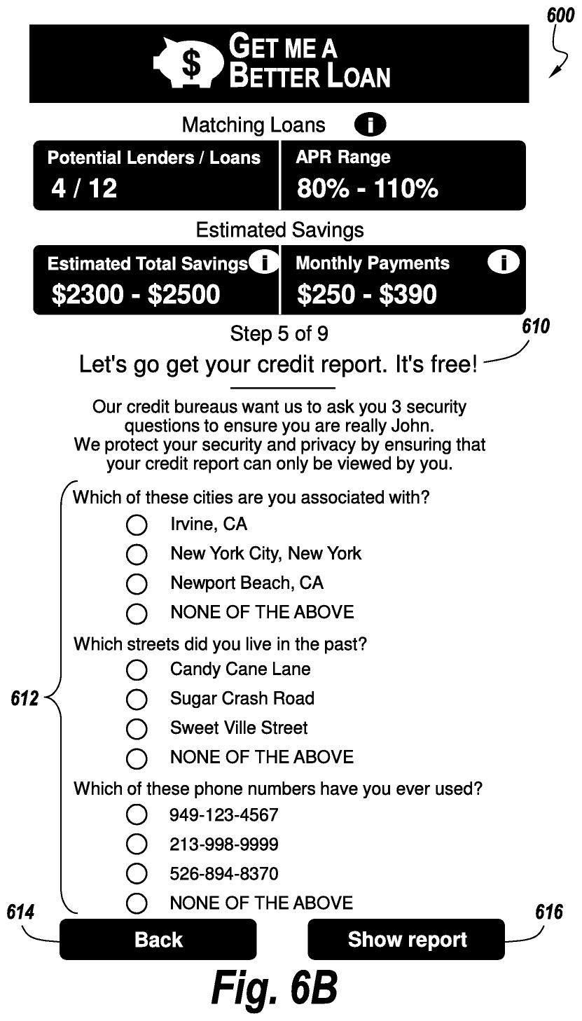

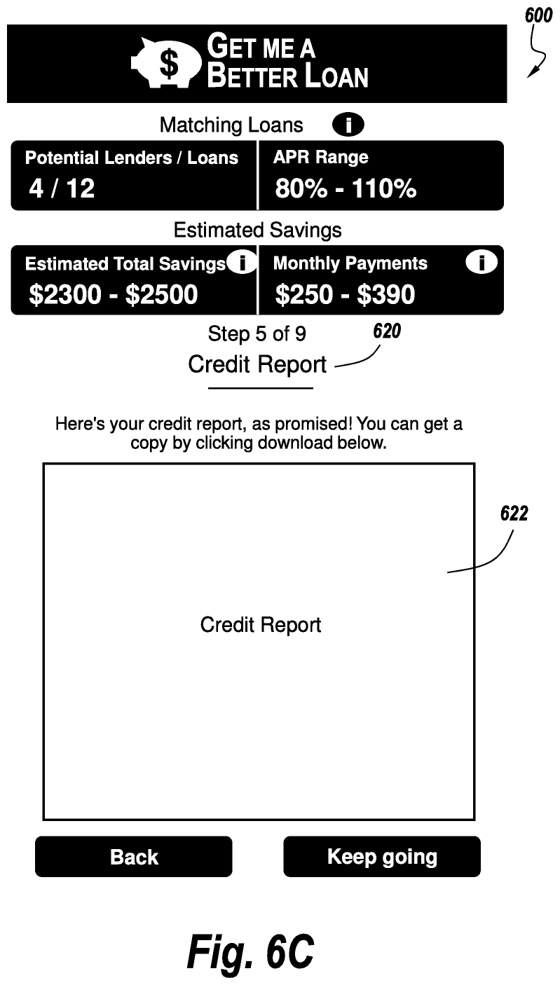

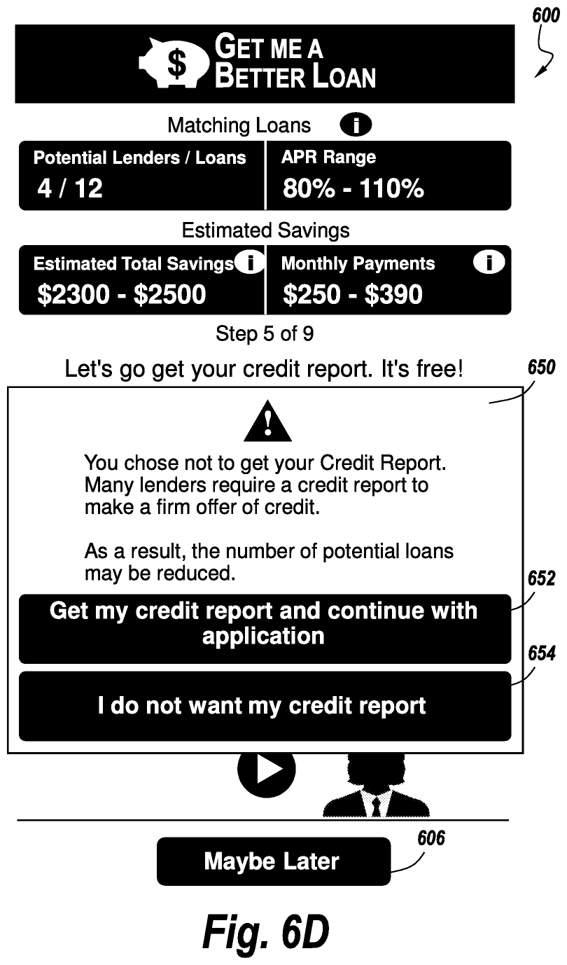

The personal information may include a credit report for the loan candidate (see step 304 in FIG. 3). The online lending platform may provide a mechanism to obtain the credit report for the loan candidate. As shown in FIG. 6A, in an illustrative user interface 600, information 602 is provided to solicit obtaining a credit report on behalf of loan candidate. A button 604 may be activated to initiate the process of obtaining the credit report on behalf of a loan candidate. A video 605 is provided to provide credit coaching regarding getting the credit report. The loan candidate also has the option of selecting button 606 for not obtaining immediately the credit report.

In instances in which the loan candidate requests to obtain the credit report, such as by activating button 604, the user interface 600 may gather additional information 610 that facilitates obtaining the credit report. In particular, verifying information 612 may be gathered to ensure that the party requesting the credit report is indeed the loan candidate. Button 614 allows a return to the previous user interface screen and button 616 prompts the obtaining and showing of the credit report. As shown in FIG. 6C, the updated user interface 600 may hold a credit report information 620. In particular, the credit report may be shown in window 622. The credit report information is also passed to the online lending platform to process the information contained therein.

In the instance in which, the loan candidate has selected button 606, a notice 650 like that shown in FIG. 6D may be displayed. This notice 650 may include button 652 to get the credit report or button 654 to not get the credit report. Not getting the credit report may result in the loan candidate not qualifying for certain loan products.

Once the online lending platform has obtained the credit report, the online lending platform performs a comparison of information obtained directly from the loan candidate via the above-described user interfaces to corresponding information contained in the credit report. In section 702 of user interface 700, the online lending platform identifies discrepancies and asks for the loan candidate to reconcile these discrepancies. For example, as shown in 704, the credit report lists the lender name as Cash Call whereas the loan candidate has entered Prosper as the lender name. The loan candidate then selects either the information from the credit report or the information entered by the loan candidate. Buttons 703, 705 for each may be displayed. The loan candidate is invited to click on the proper value. Similarly, discrepancies are shown in element 706 for the remaining loan balance and an element 708 for the interest rate.

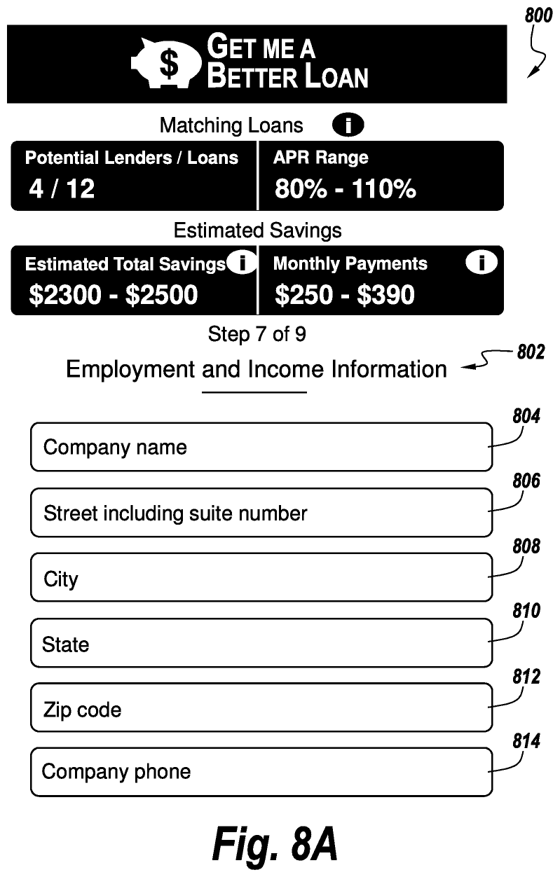

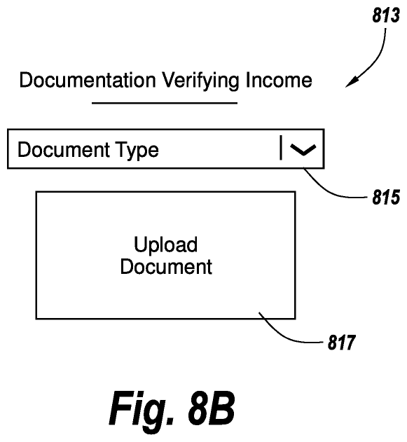

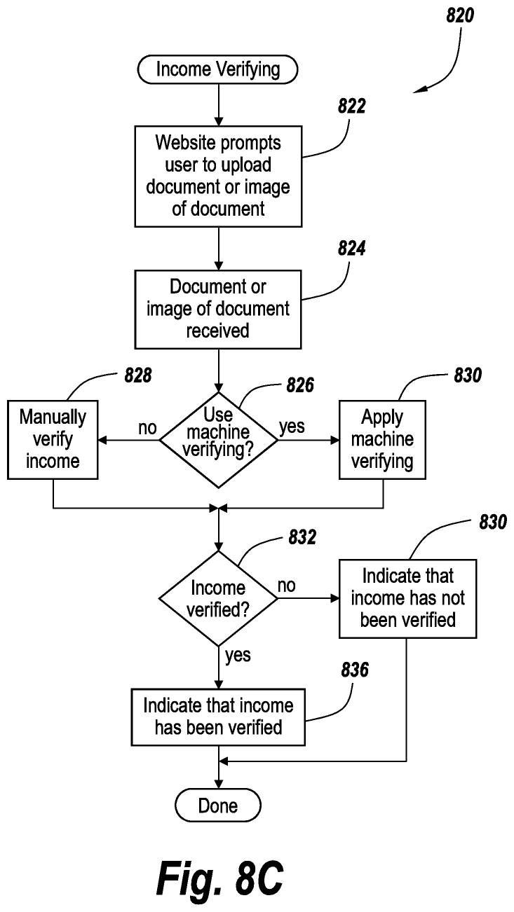

Among the personal information requested by the online lending platform is employment and income information. FIG. 8A depicts and illustrative user interface 800 in which employment income information 802 is solicited. Field 804 is for the name of the current employer, whereas field 806, 808, 810 and 812 are for address information for the employer. Field 814 is for information for employer phone number.

As was mentioned above, the online platform may include user interface for requesting a party to upload income verifying documents or images of income verifying documents. FIG. 8B shows an example of an illustrative user interface 813 for uploading income verifying documents. The user interface 813 may include a document type drop down list that enables the loan candidate to specify the type of document being uploaded (e.g., pay stub, W-2 form bank statement, etc.). The document itself may be uploaded or an image thereof (such as a picture from a smartphone of the document) may be uploaded. The load candidate may use the upload document button 817 to upload the document.

FIG. 8C shows an example of a flowchart 820 of steps that may be performed to verify income for a loan candidate. Initially, in step 822, the website prompts the user to upload a document or an image of a document that contains income verifying information like that shown in FIG. 8B. The document or image of the document is received in the online lending platform (step 824).

Once the document or image of the document is received, the online lending platform must then take steps to verify that the documents are legitimate and that the income information specified is verified by the document. The verifying may be done manually and/or may be done via computerized means. Hence, in step 826 a decision is made whether to use machine verification or manual verification. If machine verification is to be used, image recognition software and other intelligent machine learning technology may be applied to extract the appropriate information from the documents into verify legitimacy of the documents. Moreover, comparison may be made to the income information entered by the loan candidate (see step 830). This process may also be manually performed in step 828. If the income is verified (see step 832), an indication is presented to the party indicating that the income has been verified (step 836). Conversely, if the income is not verified in step 832, an indication may be generated to indicate that the income has not been verified (step 834). This may take a form of a user interface output or the like.

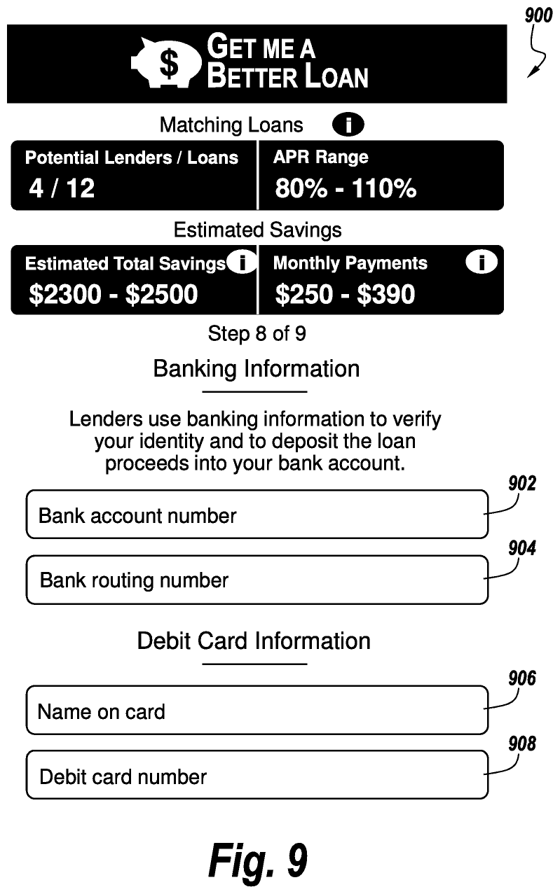

Verification may also be obtained by obtaining banking and debit card information from the loan candidate. FIG. 9 shows an illustrative user interface 900 that is used to gather this information. Field 902 is for the bank account information, and field 904 is for obtain routing number information for an account for the loan candidate. Similar information may be gathered for a debit card of the loan candidate. In particular, field 906 is used to enter the name on the debit card, and field 908 is used to gather a debit card number for the loan candidate. When this information is obtained, the bank may be contacted or the credit report information for the bank may be viewed to verify income.

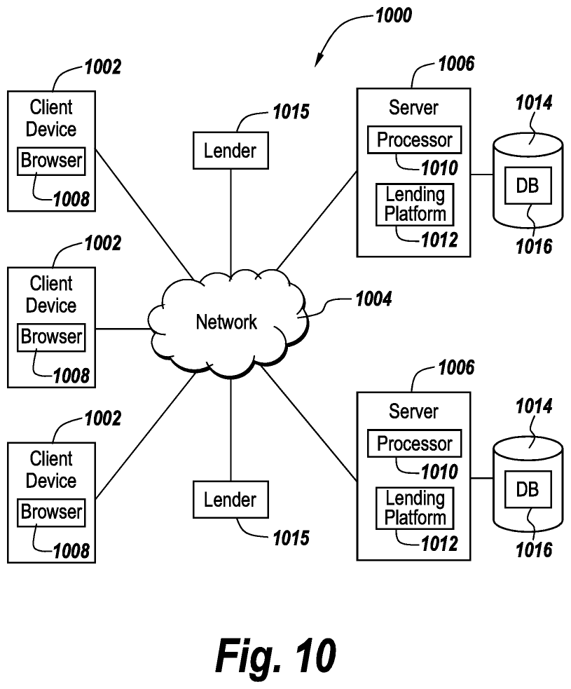

FIG. 10 depicts an illustrative distributed environment 1000 in which exemplary embodiments may be practiced. It should be appreciated that this depiction is intended to be illustrative and not exhaustive. Other configurations may be used to practice the exemplary embodiments. In exemplary embodiments client devices 1002 communicate over a network 1004 with a server devices 1006. The network 1004 may be for example, a wide area network, like the Internet, or a local area network. Client devices 1002 may take many different forms, including that of a computing device, a smart phone, a gaming system or other device that is capable of performing requisite actions to communicate over the network 1004 with the servers 1006. Each client device 1002 may include a web browser 1008 that enable communication with a server devices 1006 to access a website. The browsers 1008 may interpret markup language documents, such as HTML documents, and XML documents. The server devices 1006 may include one or more processors 1010, and the processors 1010 may execute code for the lending platform 1012. There may be a single server device 1006 or there may be a multiple server devices 1006 depending on the needs and number of client devices 1002. Each server device 1006 has access to one or more form of storage 1014. The storage may hold a database 1016 with an associated database management system (DBMS). The storage 1014 may be connected with the server devices 1016 or may be located remotely, such as on the cloud. The storage devices 1014 may hold information regarding the lending products, lenders, loan information, personal information, etc. The storage device may hold instructions that may be executed by the processors 1010 to realize the functionality here.

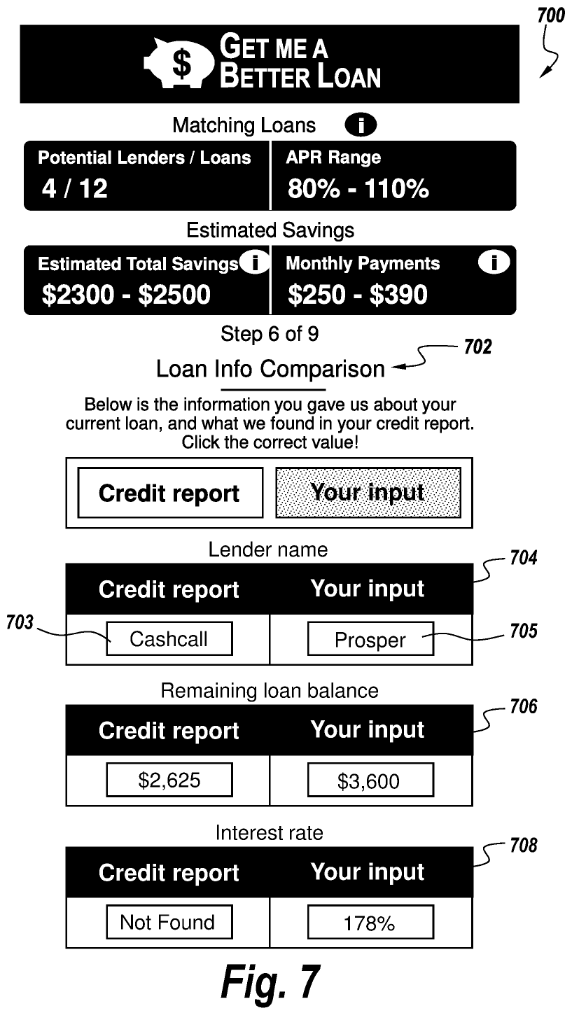

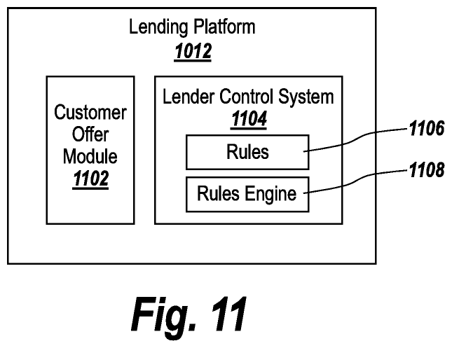

FIG. 11 depicts the lending platform 1012 and a couple of modules that may be found with the lending platform. The lending platform 1012 may include a consumer offer module 1102. The consumer offer module 1102 may be a web application and may provide the user interface elements that a lone candidate uses to provide the requisite loan and personal information. These user interfaces may be transmitted from a server to a client for display or from an app running on the client in some instances. For instance, the consumer offer module 1102 may provide user interface elements like those contained in FIGS. 4A-8A. As was mentioned above, as the loan candidate steps through the loan offer application process, the loan candidate is asked to fill out numerous fields that may be required or may be optional. The fields may vary depending upon the values provided by the loan candidate. The consumer offer module 1102 is also actively seeking matching loan offers and applying the filters discussed above. The lending platform may be realized in software that is executed by the processors 1010 of the server devices 1006. In some alternative embodiments, the online lending platform may be realized by software running both on the server device 1006 and the client devices 1002.

The lender control system 1104 is a module that lenders use to access account information. This lender control system 1104 is also used to define products, create rules and the like, as has been described above. The lender control system may provide the rules Engine 1108 for processing rules 1106 to perform the filtering of loan products for a loan candidate. The rules engine 1108 may be implemented as a script or other programming mechanism.

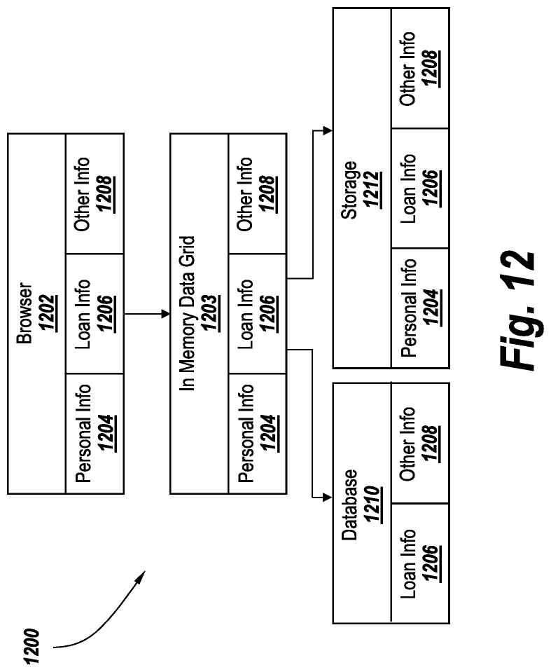

FIG. 12 depicts a dataflow diagram 1200 of information from the loan candidate to storage in exemplary embodiments. A browser 1202 at the client device display web pages for entering personal information 1204, loan information 1206 and other information 1208. This information is obtained on the server devices and stored in memory data grid 1203 and then appropriately stored in either database 1210 or else wherein storage 1212. The database 1210 may hold loan information 1206 and other information 1208, and the storage may hold personal information 1204, loan information 1206 and other information 1208 as shown.

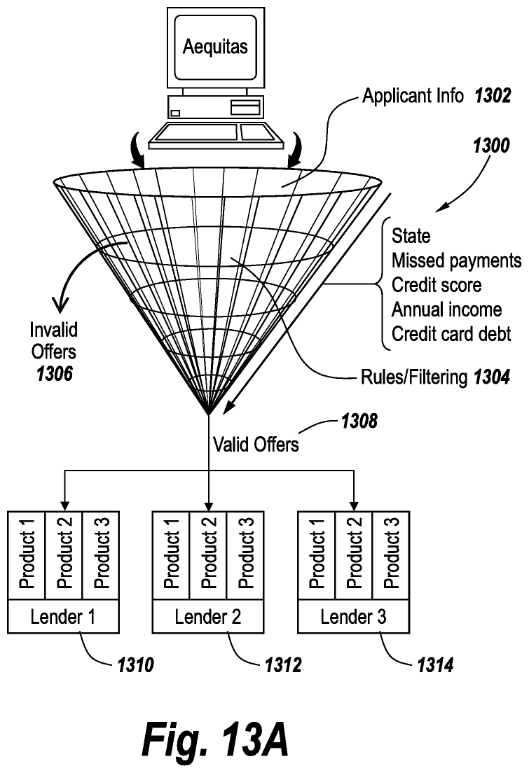

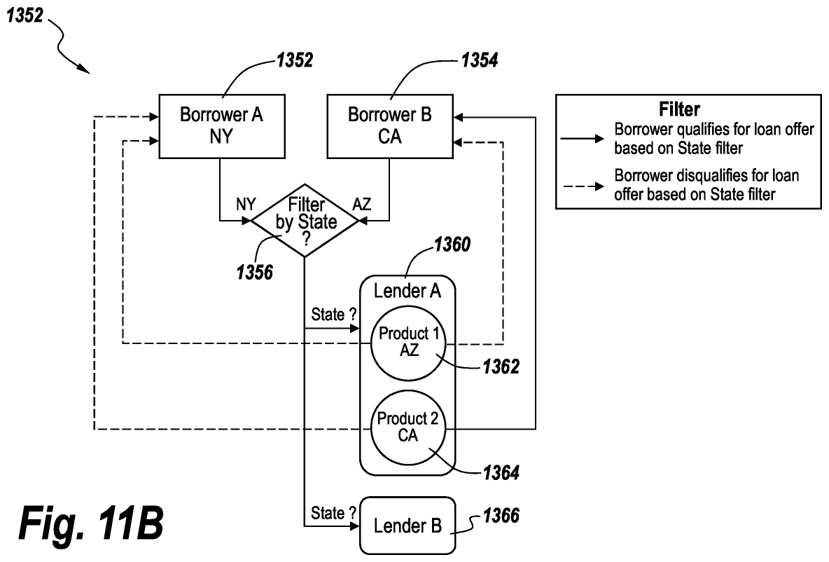

As was mentioned above, the online lending platform performs filtering based upon information provided regarding the loan and personal information. FIG. 13A depicts the flow of information and the resulting filtered output of invalid offers and valid offers. Initially, the information reflected in the set of qualifying information 1302 is gathered. The rules 1304 are applied via a Rules Engine or other script to filter out loan products for which the loan candidate is not qualified. The rules and filtering 1304 are applied using the loan candidate information and information regarding the loan and the loan that is being replaced to result in valid offers 1308. As a loan product is no longer qualified, it is removed from the qualified loan products and put into the invalid loan products 1306. In the depiction in FIG. 13A, Lender 1, Lenders 2 and Lenders 3 each have three loan products designated as Product 1, Product 2 and Product 3 that are deemed to be valid offers.

FIG. 13B gives an example of the filtering. In this example a borrower from New York 1352 and a borrower from California 1354 use the online lending platform to attempt to get a loan product. Filtering is applied by state Lender 1360 has a product for Arizona 1362 and a product for California 1364. Since borrower A is neither an Arizona resident nor a California resident, Product 1362 and Product 1364 are not qualified products for Borrower 1352 because the borrower is in New York. Borrower 1354, however, qualifies for the product 1364 for California since the borrower is a resident in California. The Borrowers 1352 and 1354 can qualify for products from Lender 1366 since Lender 1366 has products that are not limited to particular states.

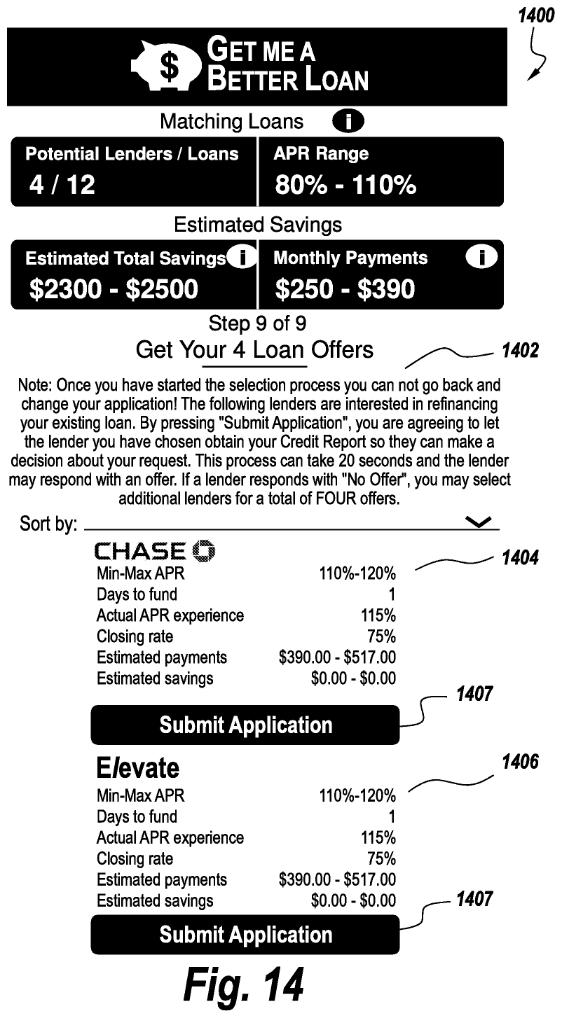

Once the following is complete and the possible loan offers are provided, the qualified loan products may be displayed such as shown in FIG. 14 for illustrative user interface 1400. As is noted in section 1402, for this illustrative case, there are four loan products for which offers are available. Two of these offers 1404 and 1406 are shown and a button 1407 is provided for selection to submit the application to receive the associated offer.

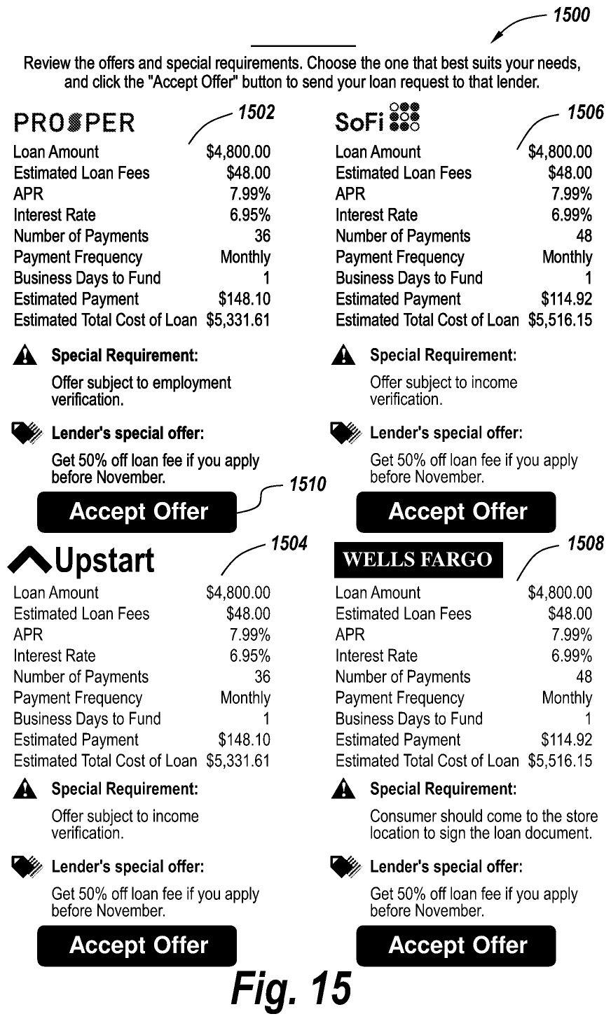

When the loan candidate makes such a submission of the application, firm offers of credit will be presented and made available for acceptance such as shown in FIG. 15. In FIG. 15, the user interface 1500 shows four offers 1502, 1504, 1506 and 1508. As can be seen, the details of the offer specifies such a loan amount, fees, APR, interest rate, number of payments, payment frequency and the like. A button 1510 may be provided for the loan candidate to accept the offer.

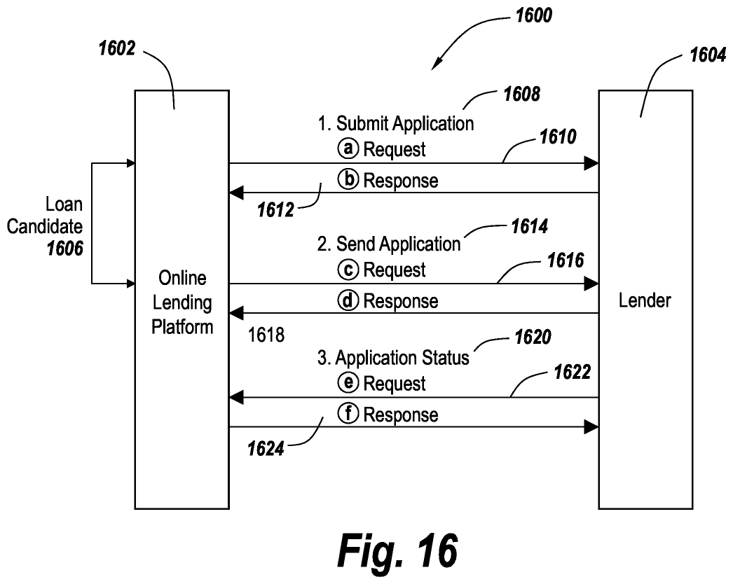

A number of application program interfaces (APIs) are defined to facilitate communication between the online lending platform and the various lenders that provide loan products on the online lending platform. FIG. 16 shows a diagram 1600 depicting the interactions between the online lending platform 1602 and the lender 1604. Broadly speaking, there are APIs to find to submit an application by a loan candidate requesting loan offers from lenders. In particular, APIs are provide to submit a request 1610 containing the set of qualifying information obtained from the consumer 1606 via the user interface, credit reports and income verifying documents. This request 16010 is sent from the online lending platform to the lender 1604. The lender then may use to find calls in the API to send a response 1612. The response takes the form of a loan offer for the loan candidates. The response 1612 contains a loan offer information. This information may be conveyed to the loan candidate as has been discussed above.

An API is defined for sending an application (see 1614) from the lender to the loan candidate when the loan candidate selects the offer provided by the lender 1604 (see 1614). If the loan candidate chooses the offer from the lender 1604, the online lending platform sends a request 1616 to the lender 1604. The information is largely like that contained in the request 1610 that was sent when submitting the application. The lender 1604 generates an official loan offer and sends the offer in the response 1618 to the online lending platform 1602.

The APIs also define a protocol for obtaining loan products obtaining application status information 1620. The lender 1604 sends an application status request 1622 to the online lending platform with loan status information. The online lending platform 1602 responds with a response 1624.

By defining a number of such APIs, the online lending platform 1602 is able to communicate with a number of different lenders 1604 and to standardize communications with such lenders.

The present invention has been described with reference to exemplary embodiments herein, those skilled in the art will appreciate that various changes in form and scope may be made without departing from the intended scope of the present invention as defined in the appended claims.

What is claimed as new and desired to be protected by Letters Patent of the United States is:

1. A method performed by a processor of a computing device, comprising:
transmitting a user interface to obtain personal information for a loan candidate;
receiving the personal information for the loan candidate via the user interface;
transmitting a user interface to obtain a credit report for the loan candidate;
receiving the credit report for the loan candidate;
transmitting a user interface for the loan candidate to upload a document verifying income for the loan candidate;
receiving the document verifying income for the load candidate that has been uploaded;
processing the personal information, the credit report and the document verifying income for the loan candidate to obtain a set of qualifying information for the loan candidate;
filtering loan products offered by at least one lender using the set of qualifying information to identify at least one of the load products for which the load candidate qualifies;
transmitting a user interface that indicates that the load candidate qualifies for one or more of the at least one loan products and providing an accept element that enables the loan candidate to apply for an offer of one of the one or more loan products; and
based on the load candidate applying for an offer for a given one of the one or more loan products for which the load candidate qualifies via the accept element, providing a firm offer of credit to the loan candidate for the given loan product.

2. The method of claim 1, further comprising providing an element that identifies loan products for which the loan candidate qualifies based on received information regarding the loan candidate and updating the element when additional information regarding the loan candidate is received.

3. The method of claim 1, wherein the element is updated in real time as the filtering is performed.

4. The method of claim 1, further comprising gathering verifying information from the loan candidate to help in obtaining the credit report for the loan candidate.

5. The method of claim 1, further comprising receiving qualifying rules that identify for at least one loan product what are qualifying characteristics that need to be satisfied to qualify for the at least one loan product.

6. The method of claim 5, wherein the filtering comprises applying the qualifying rules to the qualifying information.

7. The method of claim 1, wherein the user interfaces are for a smart phone.

8. A non-transitory computer-readable storage media holding instructions that when executed on a processor of a computing device perform the following:
transmitting a user interface to obtain personal information for a loan candidate;
receiving the personal information for the loan candidate via the user interface;
transmitting a user interface to obtain a credit report for the loan candidate;
receiving the credit report for the loan candidate;
transmitting a user interface for the loan candidate to upload a document verifying income for the loan candidate;
receiving the document verifying income for the load candidate that has been uploaded;
processing the personal information, the credit report and the documents verifying income for the loan candidate to obtain a set of qualifying information for the loan candidate;
filtering loan products offered by at least one lender using the set of qualifying information to identify at least one of the load products for which the load candidate qualifies;
transmitting a user interface that indicates that the load candidate qualifies for one or more of the at least one loan products and providing an accept element that enables the loan candidate to apply for an offer of one of the one or more loan products; and
based on the load candidate applying for an offer for a given one of the loan products for which the load candidate qualifies via the accept element, providing a firm offer of credit to the loan candidate for the given loan product.

9. The non-transitory computer-readable storage media of claim 8 additionally storing instructions for providing an element that identifies loan products for which the loan candidate qualifies based on received information regarding the loan candidate and updating the element when additional information regarding the loan candidate is received.

10. The non-transitory computer-readable storage medium of claim 8 wherein the element is updated in real time as the filtering is performed.

11. The non-transitory computer-readable storage medium of claim 8 additionally storing instructions for gathering verifying information from the loan candidate to help in obtaining the credit report for the loan candidate.

12. The non-transitory computer-readable storage medium of claim 8 additionally storing instructions for receiving qualifying rules that identify for at least one loan product what are qualifying characteristics that need to be satisfied to qualify for the at least one loan product.

13. The non-transitory computer-readable storage medium of claim 8, wherein the filtering comprises applying the qualifying rules to the qualifying information.

14. The non-transitory computer-readable storage medium of claim 8, wherein the user interfaces are for a smart phone.

15. A method performed by a processor of a computing device, comprising;
outputting a list of loan products available to a loan candidate;
providing a user interface for the loan candidate to enter personal information that may affect what loan products are available to the loan candidate;
receiving a first piece of personal information via the user interface regarding the loan candidate;
updating the list of loan products output based on the first piece of personal information;
receiving a second piece of personal information via the user interface the potential loan applicant; and
updating the list of loan products output based on the second piece of personal information.

16. The method of claim 15 wherein the first piece of personal information is from a credit report.

17. The method of claim 15 wherein the first piece of personal information is input to the computing device via a user interface.

18. A non-transitory computer-readable storage medium storing instructions that when executed on a processor of a computing device perform the following:
outputting a list of loan products available to a loan candidate;
providing a user interface for the loan candidate to enter personal information that may affect what loan products are available to the loan candidate;
receiving a first piece of personal information via the user interface regarding the loan candidate;
updating the list of loan products output based on the first piece of personal information;
receiving a second piece of personal information via the user interface the loan candidate; and
updating the list of loan products output based on the second piece of personal information.

19. The computer-readable storage medium of claim 18 wherein the first piece of personal information is from a credit report.

20. The computer-readable storage medium of claim 18 wherein the first piece of personal information is input to the computing device via a user interface.
